(19) United States
(12) Patent Application Publication
(10) Pub. No.: US 2025/0388066 A1
(43) Pub. Date: Dec. 25, 2025

(54) STRUCTURAL COMPOSITE DOOR FOR AN OFF-ROAD VEHICLE

(71) Applicant: Polaris Industries Inc., Medina, MN (US)

(72) Inventors: Eric KLOPP, Medina, MN (US); Macabe BRAND, Medina, MN (US); Bryan J. FINN, Medina, MN (US); Corrie ROYTEK, Medina, MN (US); Brian N. NYSSE, Medina, MN (US); Jalaj CHOUDHARY, Indore (IN); David BAGNARIOL, Medina, MN (US); Varun GULERIA, Kangra (IN); Nick LEVIN, Medina, MN (US); Joshua R. MILLIGAN, Medina, MN (US); Andrew LEAHY, Medina, MN (US)

(21) Appl. No.: 19/237,205

(22) Filed: Jun. 13, 2025

Related U.S. Application Data
(60) Provisional application No. 63/662,565, filed on Jun. 21, 2024.

(51) Int. Cl. B60J 1/17; B60J 1/10; B60J 10/76

(52) U.S. Cl. CPC B60J 1/17; B60J 1/10; B60J 10/76

(57) ABSTRACT

A structural composite door for an off-road vehicle includes multiple composite panels such as sheet molding compound (SMC) panels. The panels can define a column proximal to a rearward edge of the door. A door hinge can be connected to the door through screws extending through bushings extending through the column. The door hinge can include shearable stop screws configured to contact a stopping flange when the door is fully opened. A door check can be provided in a space defined by an arm of the door hinge. The door can include a fixed window and a movable window, separated by a divider bar composed of two pieces joined to one another. The door can include a door seal including an upper segment including wipers defining a water gutter between a roll-over protection beam and the door at an upper portion of the door where the door is closed.

### CROSS-REFERENCE TO RELATED APPLICATIONS

The present application claims priority to U.S. Provisional Patent Application No. 63/662,565, filed Jun. 21, 2024, entitled STRUCTURAL COMPOSITE DOOR FOR AN OFF-ROAD VEHICLE, which is herein incorporated by reference in its entirety.

### BACKGROUND

Off-road vehicles can include doors to a cabin, which can be enclosed at least in part by such doors. When the door is closed, a gap can exist between the body of the vehicle and the door. Water can penetrate through the gap or accumulate on or in a seal provided at the gap. Attachment of doors to hinges can be through bolts between the hinge and the door. The doors can swing freely on their hinges which add risk of damage or injury or use rod-based door check systems which can add complexity, cost, and/or bulk to the door. Using only a movable window panel can limit potential window geometry for the door, also limiting the visibility from inside the cabin.

### SUMMARY

The present disclosure is directed to a structural composite door for an off-road vehicle and off-road vehicles including the structural composite door.

A hinge assembly for an off-road vehicle door can include a stop flange configured to contact shearable stop screws, providing a door stop that can yield under high forces, for example to improve safety in case of an accident. The hinge assembly can define a space configured to accommodate a door check integral with the hinge, improving serviceability and reducing complexity of the door and its attachment to the vehicle.

The hinge assembly can be connected to a door at a thickened portion thereof, such as by bolts extending through a column defined by multiple sheet molded compound (SMC) materials. Bushings can be provided extending through the column for each bolt. This provides a relatively longer joint, allowing for use of longer bolts and improved bolt stretch to provide a more secure attachment of the door to the hinge.

A divider bar can be included in the door between a fixed glass panel and a movable glass panel. The divider bar can allow fixed glass to be provided where door geometry does not allow for movable glass, increasing the visibility through the door. The divider bar can be made in multiple segments to facilitate manufacture and assembly.

A door seal can be attached to the door by pins, improving the strength of attachment over molded-on or adhered door seals. The door seal can include a portion having a cross-sectional profile including a plurality of wipers configured to define a channel between the vehicle body, for example a portion of a roll-over protection system defining the door opening, and the door. The channel can allow water to run away from the gap between the vehicle body and the door, reducing infiltration or accumulation of water at the door seal.

In an example embodiment, a door for an off-road vehicle includes a door frame and a fixed window segment. The fixed window segment includes a first sealing member. The door further includes a movable window segment and a divider bar including a first divider bar segment and a second divider bar segment. The first divider bar segment includes a recess configured to receive the first sealing member. The first divider bar segment includes a first channel opposite the recess. The second divider bar includes a second channel. A second sealing member is disposed in at least one of the first channel and the second channel, the second sealing member configured to receive an edge of the movable window segment.

In an example embodiment, a door hinge for an off-road vehicle includes a first chassis mounting attachment including a first flange including a first opening configured to receive a fastener, a first shearable door stop extending opposite the first flange, and a first hinge attachment opening. The door hinge further includes a second chassis mounting attachment, including a second flange including a second opening configured to receive a fastener, a second shearable door stop extending opposite the second flange, and a second hinge attachment opening. The first hinge attachment and the second hinge attachment are aligned along a hinge axis. The hinge also includes a hinge arm comprising a door stop flange at a first end of the hinge arm, and a plurality of door mounting openings. The hinge arm is connected to the first and second chassis mounting attachments such that the hinge arm can rotate about the hinge axis. The hinge arm is configured to contact the first and second shearable door stops when the hinge arm is at a predetermined angle relative to the first and second chassis mounting attachments.

In an example embodiment, a door for an off-road vehicle includes a first composite panel and a second composite panel. The first composite panel and the second composite panel define a column having a cavity between the first composite panel and the second composite panel, the first composite panel being towards an exterior of the off-road vehicle and the second composite panel being towards an interior of the off-road vehicle. The door further includes a plurality of bushings, each of the plurality of bushings extending through the first composite panel and the second composite panel at the column and a plurality of fastener attachments, each fastener attachment disposed at an interior end of a respective one of the plurality of bushings.

In an example embodiment, a door seal for an off-road vehicle includes a plurality of seal segments and a plurality of connecting segments, each of the plurality of connecting segments connecting two of the plurality of seal segments. At least one of the plurality of seal segments has a first cross-sectional profile including a sealing bulb configured to contact a body of the off-road vehicle at a first region and a plurality of wipers configured to define a channel between a second region of the body and a frame of a door.

In an example embodiment, a door for an off-road vehicle includes a first panel formed of a sheet molded composite material. The first panel forms at least a part of an exterior-facing side of the door. The door further includes a second panel formed of a sheet molded composite material. The second panel forms at least a part of an interior-facing side of the door. The first panel and the second panel define a column having a cavity between the first panel and the second panel. The first panel and the second panel define at least a portion of a window opening of the door.

### BRIEF DESCRIPTION OF THE DRAWINGS

FIG. 1 shows an example off-road vehicle including a structural composite door.

FIG. 2 shows an example off-road vehicle door on an exterior-facing side.

FIG. 3 shows an example off-road vehicle door on an interior-facing side.

FIG. 4 shows an exploded view of an example off-road vehicle door.

FIG. 5 shows a sectional view of an example off-road vehicle door and window at a first divider bar segment.

FIG. 6 shows an example divider bar at a joint between a first divider bar segment and an off-road vehicle door.

FIG. 7 shows an example two-piece divider bar for an off-road vehicle door at a joint between first and second divider bar segments.

FIG. 8 shows a sectional view of an example second divider bar segment.

FIG. 9 shows a sectional view of an example off-road vehicle door at a hinge attachment.

FIG. 10 shows an example off-road vehicle door hinge on an exterior-facing side.

FIG. 11 shows an example off-road vehicle door hinge on an interior-facing side.

FIG. 12 shows an exploded view of an example off-road vehicle door hinge.

FIG. 13 shows an example door seal for an off-road vehicle door.

FIG. 14A shows a sectional view of an example first door seal segment.

FIG. 14B shows a sectional view of an example second door seal segment.

FIG. 14C shows a sectional view of an example third door segment.

FIG. 15 shows a sectional view of an off-road vehicle at an upper portion of a door.

### DETAILED DESCRIPTION

The present disclosure is directed to a structural composite door for an off-road vehicle and off-road vehicles including the structural composite door.

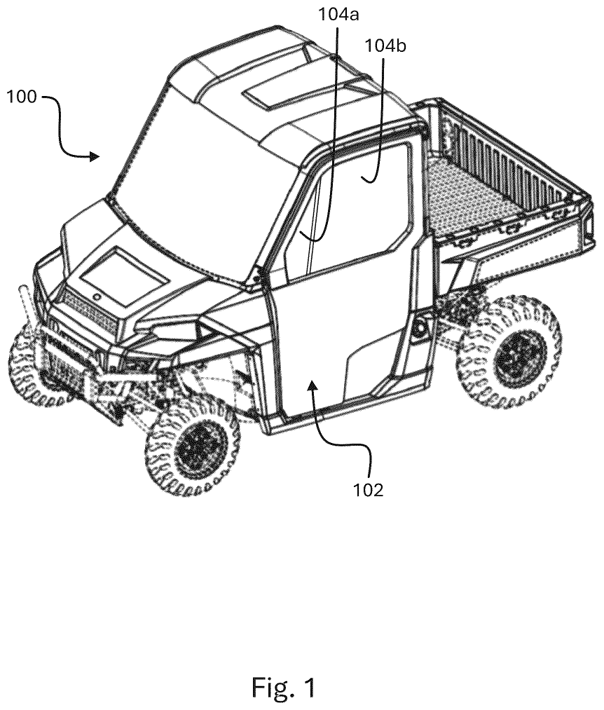

FIG. 1 shows an example off-road vehicle including a structural composite door. Off-road vehicle 100 can be, for example, an all-terrain vehicle (ATV), a utility task vehicle (UTV), a side-by-side off-road vehicle, or the like. Off-road vehicle 100 can include a vehicle door 102 allowing access to a cabin of the vehicle. The vehicle door 102 can include a window 104 including one or more segments. In the embodiment shown in FIG. 1, window 104 includes a fixed segment 104a and a movable segment 104b. In an embodiment, operator door 102 can be attached to the vehicle by way of hinges provided at a side of the door towards a rear of the vehicle 100.

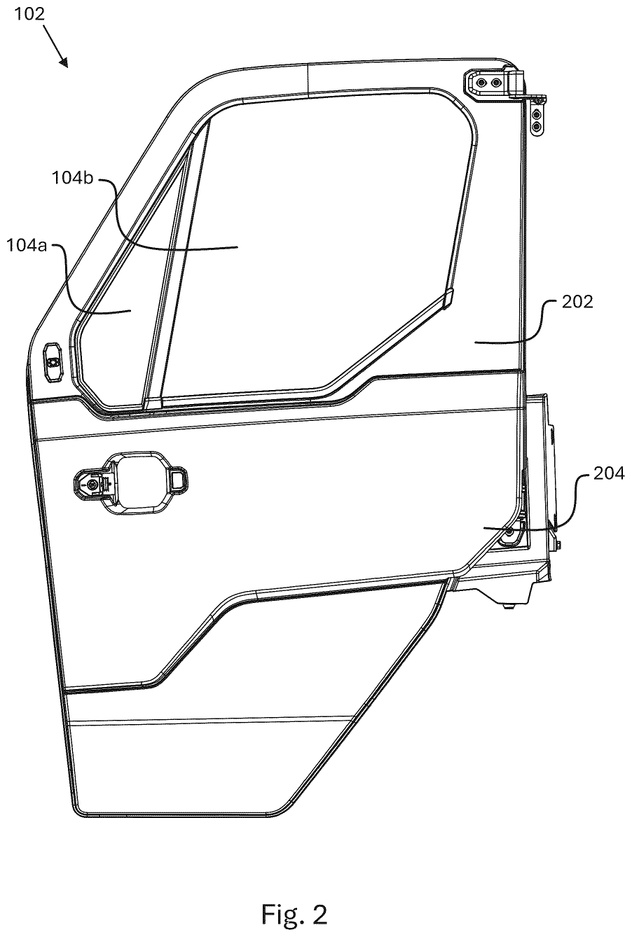

FIG. 2 shows an example off-road vehicle door on an exterior-facing side. Vehicle door 102 includes window 104 as described above. The vehicle door 102 includes an exterior panel 202. Exterior panel 202 can be formed of a composite material including a polymeric material and a filler such as glass or carbon fibers. In an embodiment, the composite material is a sheet moulding compound (SMC) material including a thermoset resin and a filler material. In an embodiment, a decorative panel 204 can be provided over at least a portion of the exterior panel 202 of the vehicle door 102. Additional features, such as a door latch handle, a hinge attachment, and the like can be provided on the exterior panel 202.

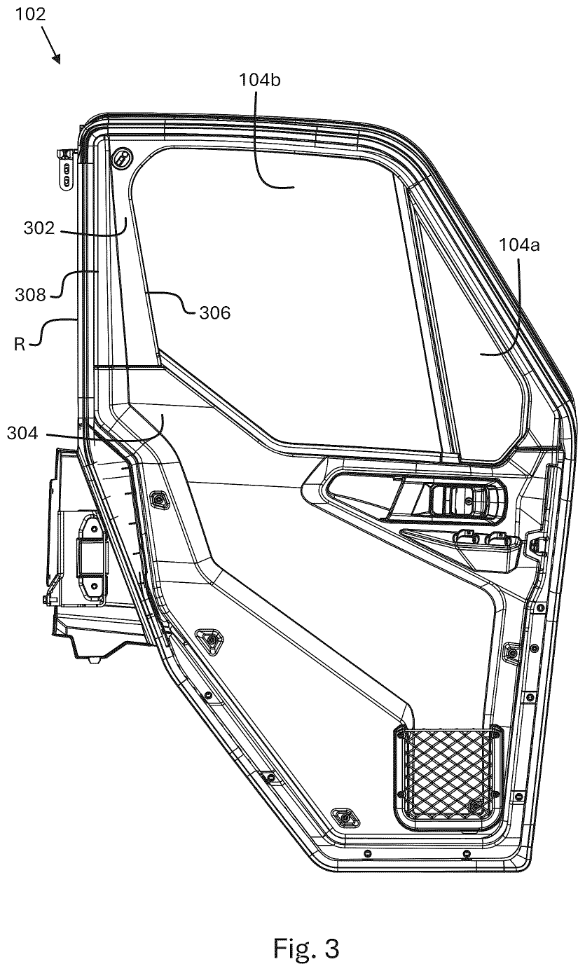

FIG. 3 shows an example off-road vehicle door on an interior-facing side. Vehicle door 102 includes a first interior panel 302 and a second interior panel 304. The first interior panel 302 can surround the window opening 306 configured to contain window 104. The first interior panel can include column 308 between the window opening and a rearward edge R of the vehicle door 102. The first interior panel 302 can be configured to be positioned directly adjacent to the exterior panel 202. At column 308, a cavity can be defined between the exterior panel 202 and the first interior panel 302. First interior panel 302 can be formed of a composite material, for example SMC material. Second interior panel 304 can provide a portion of the interior surface of the vehicle door 102, for example below the window opening 306. A portion of the second interior panel 304 can extend over a portion of the first interior panel 302, for example at column 308. Additional features can be provided on second interior panel 304, such as storage features such as netting, window controls, a door latch handle, and the like. Second interior panel 304 can be formed of a composite material, for example SMC material.

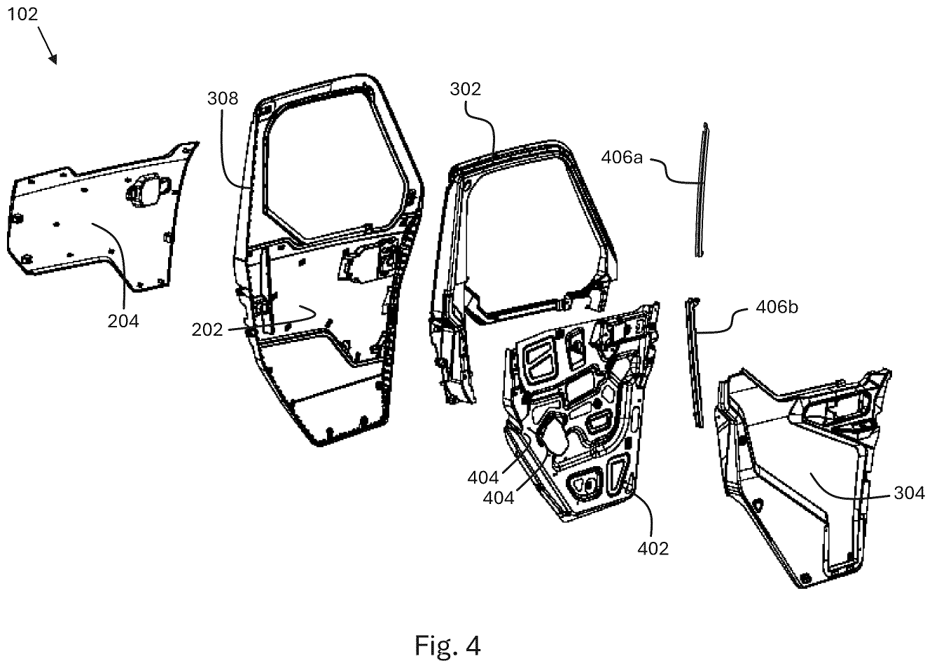

FIG. 4 shows an exploded view of an example off-road vehicle door. Fasteners, features such as a door latch assembly, window actuator, and the like are omitted from the exploded view of FIG. 4. In the exploded view of FIG. 4, In embodiments, a central panel 402 can be included in vehicle door 102. The central panel 402 can be a panel of any suitable material such as steel, aluminum, or the like. The central panel 402 can be a metal stamping. Central panel 402 can be positioned between at least a portion of the first interior panel 302 and the second interior panel 304. In an embodiment, a portion of central panel 402 extends over a portion of column 308 provided in the first interior panel 302. Central panel 402 can be entirely covered by second interior panel 304 on an interior-facing side of the vehicle door 102. The central panel 402 can include fastener attachments 404 configured to receive bolts used to attach vehicle door 102 to a hinge assembly. Fastener attachments 404 can be, for example, captive nuts, threaded openings, or any other suitable mechanical interface for receiving and securing a fastener. The fastener attachments 404 can be provided on a portion of central panel 402 extending over the first interior panel 302 at the column 308. Fastener attachments 404 can be attached to the central panel 402, for example by a weld, formed integrally with the central panel 402, or the like. Central panel 402 can further include mounting features for, for example, window actuators, a divider bar or segments thereof, and the like. It is understood that any suitable fasteners, adhesives, mechanical interface features, combinations thereof, or the like can be provided to secure components of the vehicle door 102 to one another, including joining two or more of exterior panel 202, first interior panel 302, second interior panel 304, and central panel 402 to one another.

Divider bar 406 can be provided in the vehicle door 102. Divider bar 406 can provide a track for a movable portion of a window such as movable segment 104b of window 104 described above. The divider bar 406 can include first divider bar segment 406a and second divider bar segment 406b. In an embodiment, divider bar 406 can be at least partially secured in vehicle door 102 by attachment of one or both of first divider bar segment 406a and second divider bar segment 406b to the central panel 402, for example through fasteners provided through suitable openings provided in first divider bar segment 406a and second divider bar segment 406b. First divider bar segment 406a can be provided between exterior panel 202 and first interior panel 302. First divider bar segment 406a can extend through the window opening defined by the exterior panel 202 and first interior panel 302.

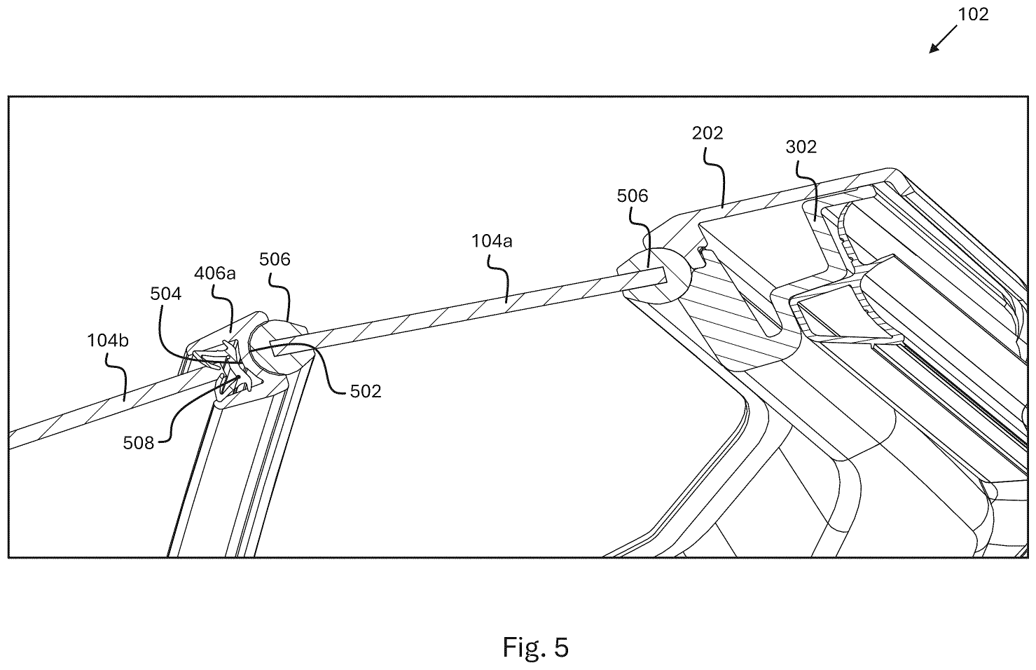

FIG. 5 shows a sectional view of an example off-road vehicle door 102 and window at a first divider bar segment. First divider bar segment 404a can include one side including a recess 502 and an opposing side where channel 504 is provided. The recess 502 can be sized and shaped to accommodate a fixed glass seal 506 provided around a perimeter of fixed segment 104a of the window 104. The fixed glass seal 506 can be any suitable sealing material such as rubber provided around the perimeter of the fixed segment 104a. In the embodiment shown in FIG. 5, the fixed glass seal 506 has a rounded profile provided opposite from the fixed segment 104a, and the recess 502 includes a corresponding curve configured to correspond with the rounded profile of fixed glass seal 506. In an embodiment, fixed glass seal 506 can also be received in a corresponding recess formed by respective portions of the exterior panel 202 and first interior panel 302. The channel 504 is configured to accommodate a movable window seal 508. Movable window seal 508 can be a strip of sealing material such as rubber configured to receive an edge of the movable segment 104b of window 104, such that the movable window seal 506 provides a seal at said edge while allowing movable segment 104b to be moved between open and closed positions.

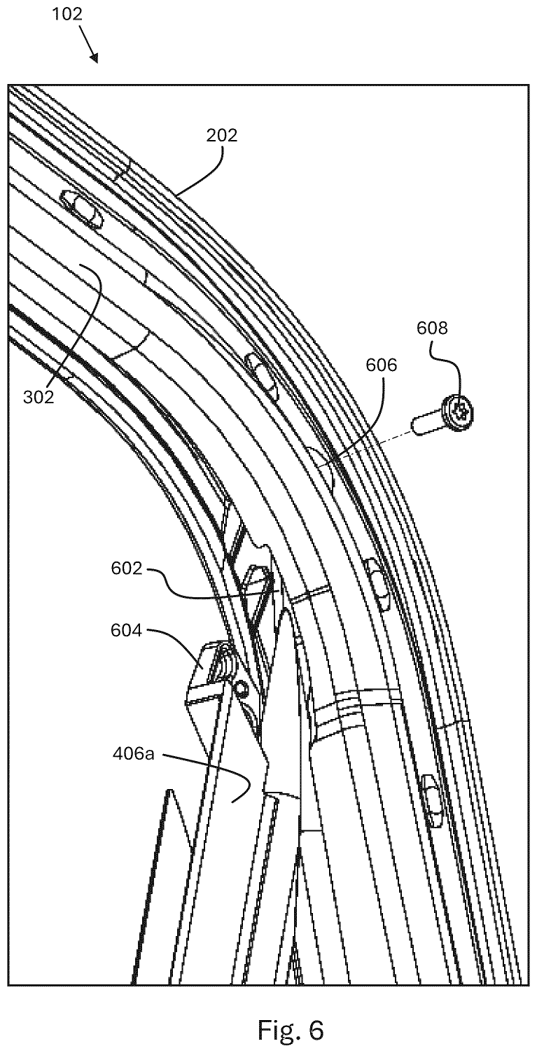

FIG. 6 shows an example divider bar at a joint between a first divider bar segment and an off-road vehicle door. In an embodiment, an end of first divider bar segment 406a can be attached to the vehicle door 102, for example between exterior panel 202 and first interior panel 302. The end of first divider bar segment 406a attached to the vehicle door 102 can be an end opposite the end of first divider bar segment 406a interfacing with second divider bar segment 406b. The end of the first divider bar segment 406a can be connected to the vehicle door 102 through, for example, a mortise and tenon joint including recess 602 formed in vehicle door 102. Recess 602 can be defined between exterior panel 202 and first interior panel 302. Recess 602 can be configured to receive a projection 604 provided at the end of the first divider bar segment 406a. A fastener opening 606 can be provided in the vehicle door 102 at recess 602, such that fastener 608 such as a screw can be used to contact the projection 604 provided at the end of the first divider bar segment 406a, so as to retain projection 604 in recess 602. In an embodiment, opening 606 can be provided in the first interior panel 302.

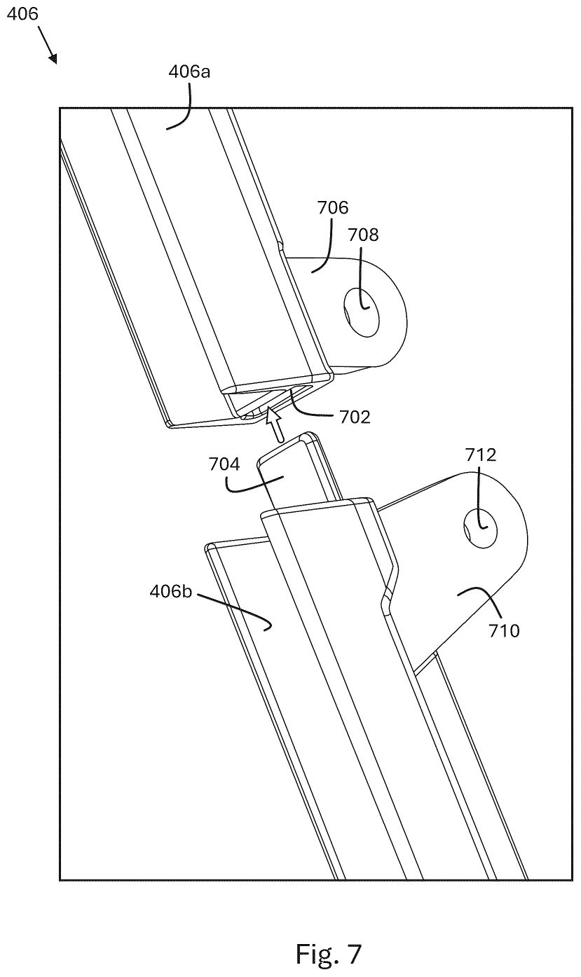

FIG. 7 shows an example two-piece divider bar for an off-road vehicle door at a joint between first and second divider bar segments. First divider bar segment 406a can include a recess 702. Second divider bar segment 406b can include a projection 704, configured to form a press-fit within recess 702. The first divider bar segment 406a can further include a first attachment projection 706 having a first attachment opening 708 configured to receive a fastener such as a bolt. The second divider bar segment Y can further include a second attachment projection 710 having a second attachment opening 712 configured to receive a second fastener such as a bolt. Fasteners provided through first and second attachment openings 708, 712 can secure the first and second divider bar segments 406a,b to other features of the vehicle door 102, for example central panel 402.

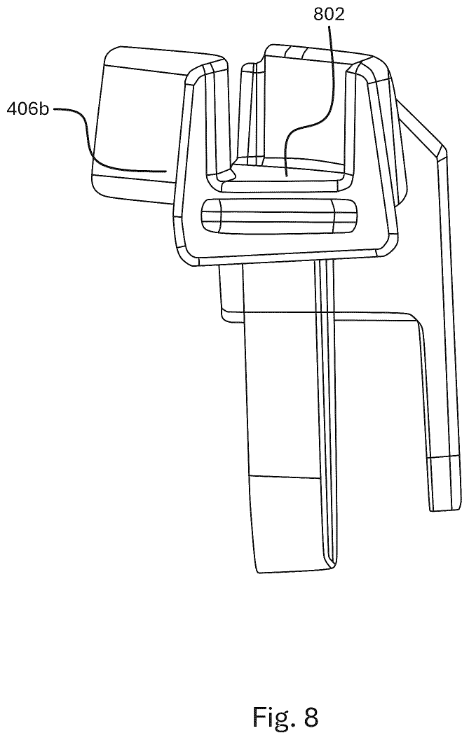

FIG. 8 shows a sectional view of an example second divider bar segment. Second divider bar segment 406b defines a channel 802. Channel 802 is configured to receive the movable window seal 508. Second divider bar segment 406b can be configured such that channel 802 is provided in line with the channel 504 provided in first divider bar 406a. In an embodiment, movable window seal 508 is provided as a continuous member extending through both channel 506 of the first divider bar segment and channel 802 of the second divider bar segment. In an embodiment, movable window seal 508 can be provided in multiple discrete segments respectively provided in channel 504 of the first divider bar segment and channel 802 of the second divider bar segment 404b.

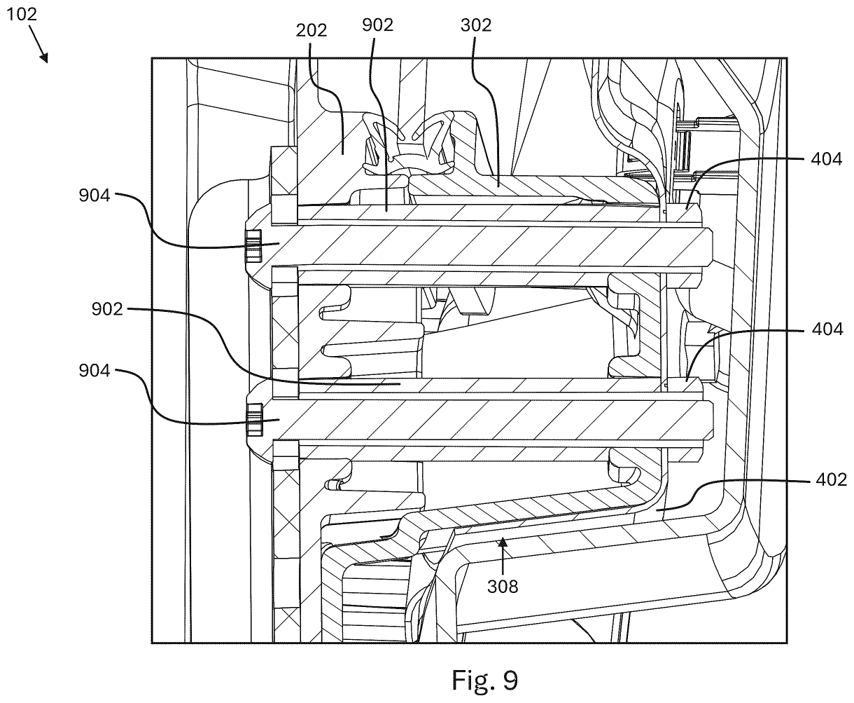

FIG. 9 shows a sectional view of an example off-road vehicle door at a hinge attachment. The section of FIG. 9 is taken at a portion of column 308 at a height where the vehicle door 102 is secured to a hinge. The portion of column 308 where the vehicle door 102 is secured to the hinge can be at a portion of vehicle door 102 where the central panel 402 extends over the first interior panel 302. Bushings 902 can be provided extending through the exterior panel 202 and the first interior panel 302. The bushings 902 can be metal bushings sized to accommodate hinge bolts 904. Bushings 902 can be configured to prevent contact between the hinge bolts 904 and the exterior panel 202 and first interior panel 302. The hinge bolts 904 can be used to secure the door to the hinge. Hinge bolts 904 can be received at fastener attachments 404, for example having threads of the hinge bolts 904 engage with respective threading on captive nuts used as the fastener attachment 404. In an embodiment, hinge bolts 904 can extend through openings provided in central panel 402 and be secured by nuts separate from central panel 402. Bushings 902 can extend in a range from three to six inches depending on the size of the cavity between exterior panel 202 and first interior panel 302 provided in column 308. By providing the hinge bolts 904 at a portion of the vehicle door 102 having relatively greater thickness due to the cavity provided at column 308, longer bolts can be used, improving bolt stretch properties and providing for a more secure joint securing the vehicle door 102 to the corresponding hinge.

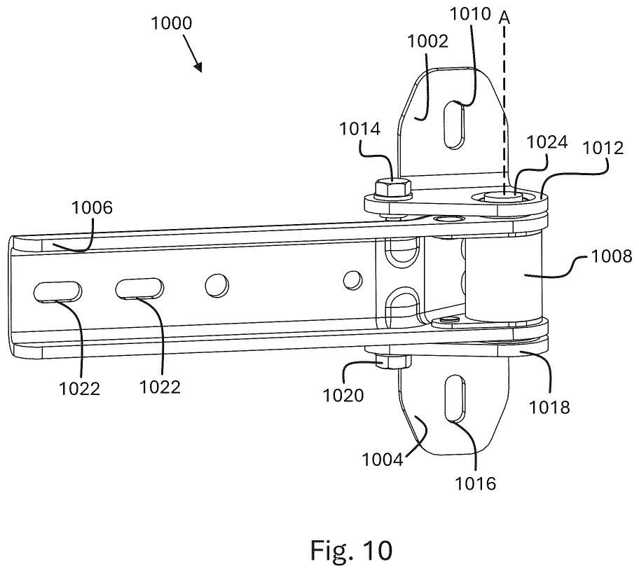

FIG. 10 shows an example off-road vehicle door hinge on an exterior-facing side. Door hinge assembly 1000 includes first chassis attachment 1002, second chassis attachment 1004, hinge arm 1006, and door check 1008. First chassis attachment 1002 includes a first chassis fastener opening 1010, a first hinge attachment flange 1012, and a first shearable door stop 1014. The second chassis attachment 1004 includes a second chassis fastener opening 1016, a second hinge attachment flange 1018, and a second shearable door stop 1020. In an embodiment, the first and second chassis attachments 1002, 1004 can be mirror images of one another. In an embodiment, first and second chassis attachments 1002, 1004 can differ in shape, so long as first and second hinge attachment flanges 1012, 1018 include openings in line with one another along hinge axis A. The hinge arm 1006 can include one or more door mount openings 1022. Hinge pin 1024 can extend through the first hinge attachment flange 1012, hinge arm 1006, door check 1008, and second hinge attachment flange 1018 along the hinge axis A.

First chassis fastener opening 1010 and second chassis fastener opening 1016 can be openings provided on the respective first and second chassis attachments such that a fastener such as a bolt can extend through the opening to secure the hinge assembly to a chassis of a vehicle. The first and second chassis fastener openings 1010, 1016 can be circular openings for receiving the fastener or extended in a lateral or longitudinal direction to allow for some variation in the position of the fasteners, for example to allow for manufacturing tolerances or the like. First chassis fastener opening 1010 and second chassis fastener opening 1016 can be provided on respective portions of the first and second chassis attachments 1002, 1004 each extending away from the hinge arm 1006 in a direction having a component along hinge axis A.

First and second hinge attachment flanges 1012, 1018 extend outwards from the respective first and second chassis attachments 1002, 1004 with respect to the vehicle when first and second chassis attachments 1002, 1004 are attached to said vehicle. First and second hinge attachment flanges 1012, 1018 can each include a respective opening through which the hinge pin 1024 can extend. The respective openings in first and second hinge attachment flanges 1012, 1018 can have respective centers along the hinge axis A.

First and second shearable door stops 1014, 1020 can be provided on the respective first and second chassis attachments 1002, 1004. In an embodiment, the first and second shearable door stops 1014, 1020 extend from the respective first and second hinge attachment flanges 1012, 1018. The first and second shearable door stops 1014, 1020 can extend into a travel path of the hinge arm 1006 such that a portion of the hinge arm 1006 contacts at least one of the first and second shearable door stops at a predetermined opening angle of the door. In an embodiment, the first and second shearable door stops 1014, 1020 are configured to stop the movement of hinge arm 1006 at an opening angle in a range from 75 to 80 degrees relative to the closed position. The first and second shearable door stops 1014, 1020 can be configured to stop movement of the door unless force exceeds a predetermined amount of force. First and second shearable door stops 1014 can be configured to be sheared by the hinge arm 1006 when a force applied to the door when the door is at the predetermined opening angle exceeds the predetermined amount of force. In an embodiment, the predetermined amount of force can be approximately 100 pounds of force applied at an edge of the door opposite the side of the door proximal to where the hinge is attached. The first and second shearable door stops 1014, 1020 can be configured to be replaceable after shearing, for example being pins provided through openings provided on the respective first and second hinge attachment flanges 1012, 1018. Following shearing of the first and second shearable door stops 1014, 1020, remaining portions of the first and second shearable door stops 1014, 1020 can be removed from the first and second hinge attachment flanges 1012, 1018 and new door stops can be installed. In an embodiment, one of first shearable door stop 1014 or second shearable door stop 1020 can be omitted. In an embodiment, first and second shearable door stops 1014, 1020 can be replaced by a single shearable pin extending from first chassis attachment 1002 to second chassis attachment 1004.

Hinge arm 1006 can be rotatably attached to the first and second chassis attachments 1002, 1004 by hinge pin 1024. The hinge arm 1006 can include one or more door mount openings 1022 configured to allow a fastener to pass through hinge arm 1006 so as to secure hinge arm 1006 to a vehicle door. Door mount openings 1022 can be round or extended in a lateral or longitudinal direction to allow for some variation in the position of the fasteners. Other openings can be provided in hinge arm 1006, for example to allow for manufacturability, tooling, attachment of decorative elements, or the like. In an embodiment, hinge arm 1006 is shaped to provide a space capable of accommodating door check 1008.

Door check 1008 can be included around hinge pin 1024. Door check 1008 can resist rotation of the door at one or more predetermined positions. Door check 1008 can be a pin-type door check disposed along the hinge axis A. The predetermined positions for door check 1008 can be one or more door opening angles that are smaller than a door opening angle at which hinge arm 1006 contacts the first and second shearable door stops 1014, 1020. In an embodiment, the predetermined positions for door check 1008 can be at opening angles of approximately 35 degrees, approximately 48 degrees, and approximately 61 degrees with respect to the closed position of the door. Door check 1008 can be provided integrally to the hinge assembly 1000. In an embodiment, door check 1008 is the sole door check feature providing stops at the predetermined positions, for example, the off-road vehicle and the door thereof can omit any other door check assemblies such as a rod-type door check assembly.

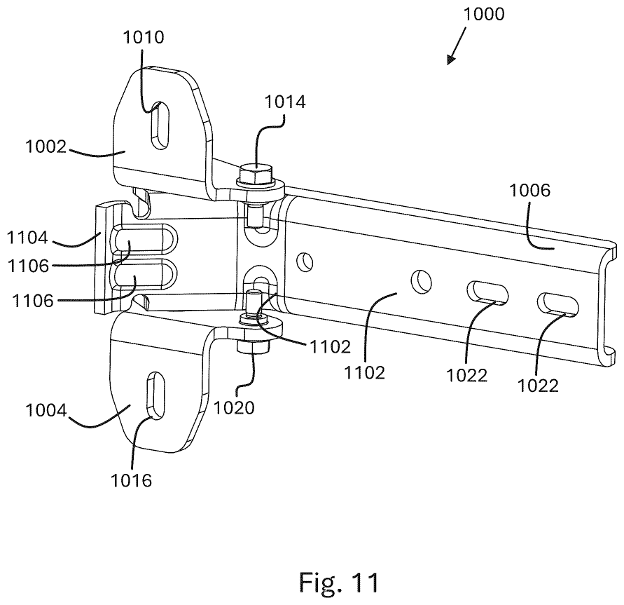

FIG. 11 shows example off-road vehicle door hinge 1000 on an interior-facing side. In the view of FIG. 11, the hinge arm 1006 can be seen to include recesses 1102 and shearing pin contact surface 1104. Reinforcement features 1106 can also be provided in hinge arm 1006.

One or more recesses 1102 can be formed in hinge arm 1006 such that when the door is closed the first and second shearable door stops 1014, 1020 can be accommodated in recesses 1102. Recesses 1102 can be configured to prevent the hinge arm 1006 from interfering with first and second shearable door stops 1014, 1020 outside of when the hinge arm 1006 is opened to the predetermined opening angle, for example when the hinge arm 1006 is in the closed position. The recesses 1102 can have any suitable shape for accommodating the door stop features included in hinge assembly 1000. In an embodiment, the recesses 1102 can be omitted if the hinge arm 1006 would not interfere with the first and second shearable door stops when the door is in the closed position.

Shearing pin contact surface 1104 is a portion of hinge arm 1006 configured to contact shearable door stop features such as first and second shearable door stops 1014, 1020. The shearing pin contact surface 1104 can have any suitable shape and position to engage with the shearable door stop features provided on hinge arm 1006. In an embodiment, shearing pin contact surface 1104 can be provided as a flange at an end of the hinge arm 1006 opposite an end of hinge arm 1006 where the door mount openings 1022 are provided.

Reinforcement features 1106 can optionally be provided in hinge arm 1006. The reinforcement features can be features such as dimples, bulges, thickened regions, or the like provided to increase a mechanical strength of the hinge arm 1006 or one or more portions thereof. In the embodiment shown in FIG. 11, the reinforcement features 1106 include two bulging regions provided near the shearing pin contact surface 1104 to stiffen the shearing pin contact surface 1104.

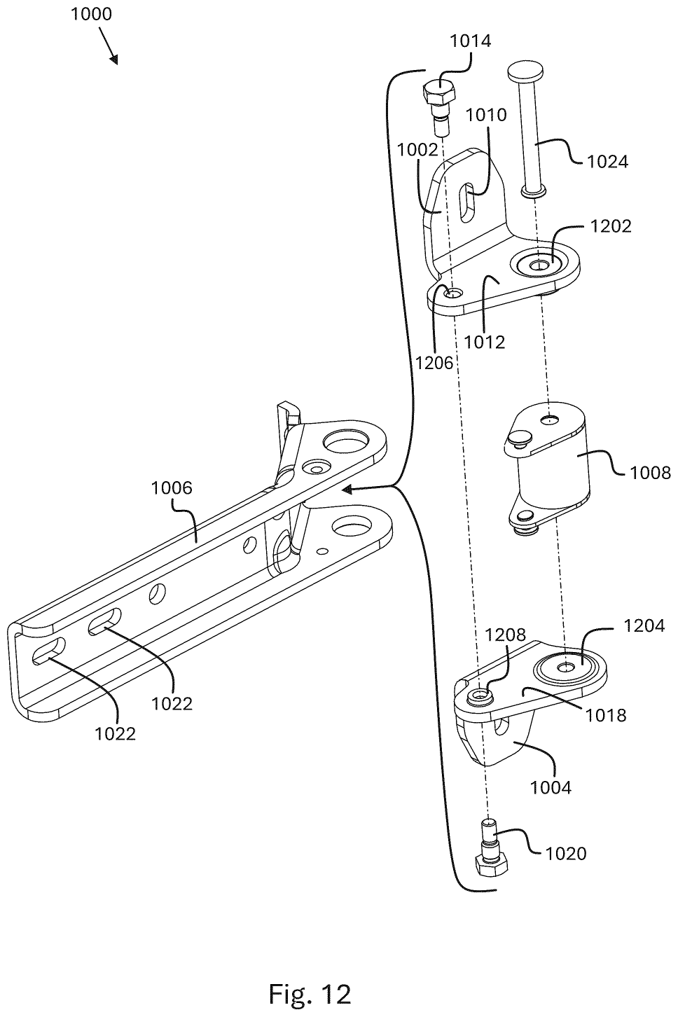

FIG. 12 shows an exploded view of example off-road vehicle door hinge 1000. In the exploded view of FIG. 12, the first and second hinge pin openings 1202, 1204 can be seen in first and second chassis attachments 1002, 1004. First and second hinge pin openings 1202, 1204 can be configured to receive the hinge pin 1024 such that hinge arm 1006 is rotatably secured between the first and second chassis attachments 1002, 1004. Additionally, the first and second door stop openings 1206, 1208 can be seen in first and second chassis attachments 1002, 1004. The first and second door stop openings 1206, 1208 can be configured to receive the first and second shearable door stops 1014, 1020 such that the respective door stops are provided in a path of travel of the shearing pin contact surface 1104 of the hinge arm 1106.

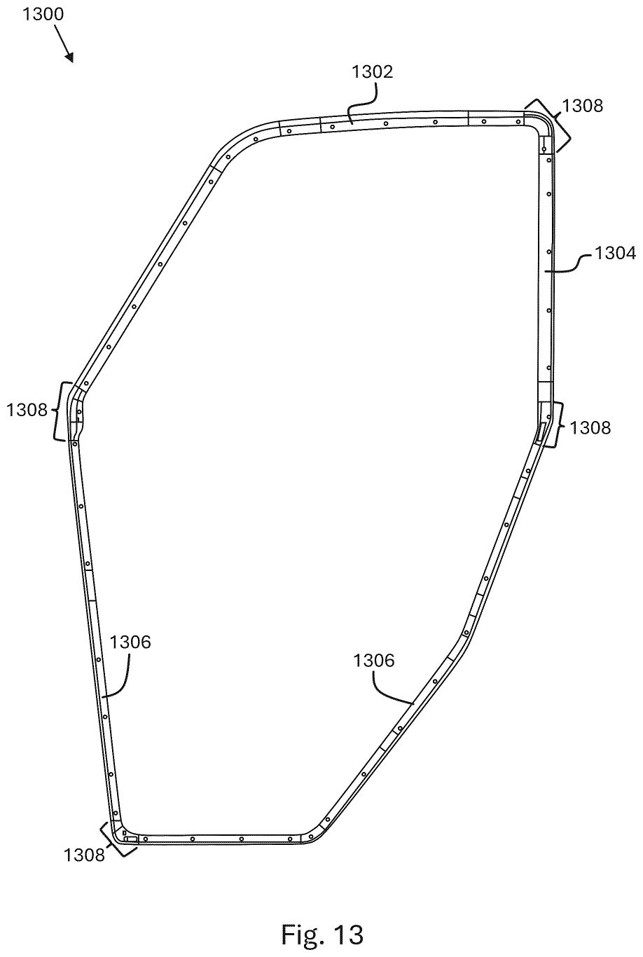

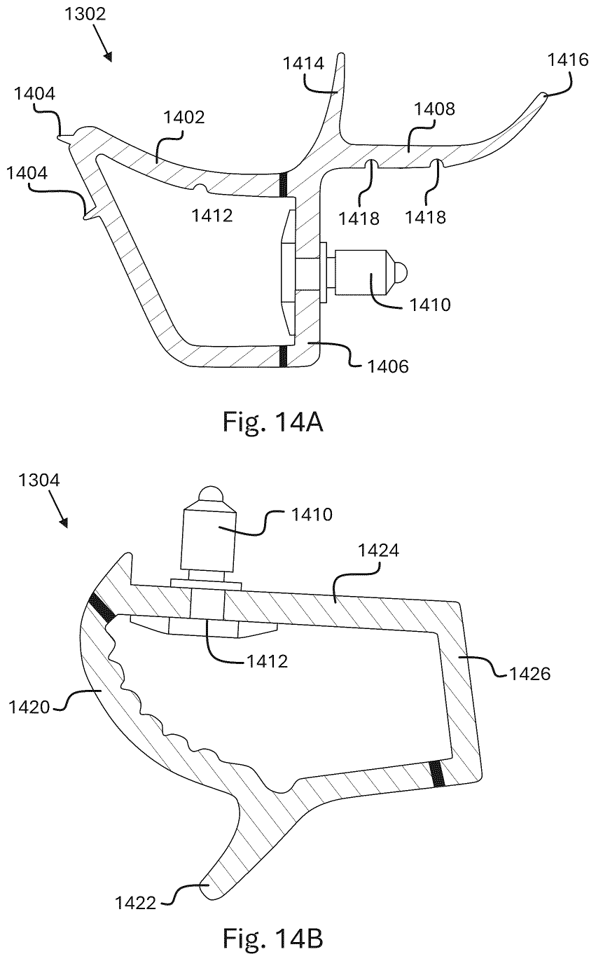

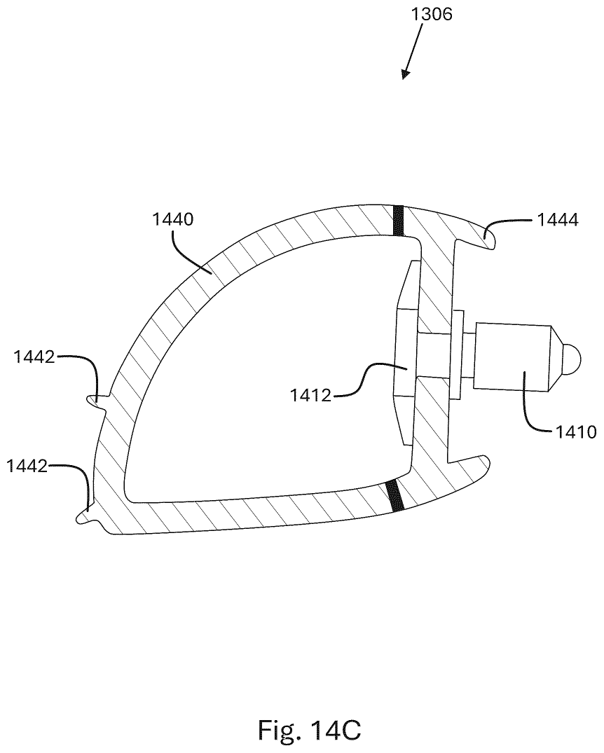

FIG. 13 shows an example door seal for an off-road vehicle door. Door seal 1300 includes first door seal segment 1302, second door seal segment 1304, and third door seal segment(s) 1306. First door seal segment 1302 extends along an upper edge of the door seal 1300 and is configured to extend along an upper portion of a door when door seal 1300 is installed. Second door segment 1304 can extend vertically along a portion of a rearwards edge of the door when door seal 1300 is installed. Third door seal segment 1306 can form a lower portion of the door seal 1300 including portions extending across front, rear, and bottom edges of the door when door seal 1300 is installed. The third door seal segment 1306 can be composed of two or more continuous seals, joined by connecting segments 1308, for example at one or more corners third door seal segment 1306 extends around. Connecting segments 1308 can be provided at transitions between first, second, and third door seal segments 1302, 1304, and 1306. A connecting segment 1308 can also be provided between two parts of third door seal segment 1306, for example at a corner of the door seal 1300 towards a lower front corner of door seal 1300 relative to a door to which door seal 1300 can be attached. Each of first door seal segment 1302, second door seal segment 1304, and third door seal segment 1306 can have a different respective cross-sectional shape as shown in FIGS. 14A-14C. Connecting segments 1308 can be molded from a polymer material.

FIG. 14A shows a sectional view of an example first door seal segment. First door seal segment 1302 includes a bulb 1402 including two wipers 1404 extending therefrom. Bulb 1402 and wipers 1404 can be configured to form a seal against a first part of a body of a vehicle the door including first door seal segment 1302 is attached to, for example a tube of a roll-over protection system or a particular portion thereof. The bulb 1402 and wipers 1404 can be made of a spongy seal material, for example, Ethylene-propylene diene monomer (EPDM) rubber, having a relatively lower density than a dense form of said seal material. The dense and spongy forms of the seal material can be co-extruded when forming the first door seal segment 1302. The first door seal segment 1302 further includes attachment region 1406 and gutter region 1408. The attachment region 1406 and the gutter region 1408 can be formed of the dense form of the seal material. The attachment region 1406 can be a planar region configured to face the door first door seal segment 1302 is to be attached to.

Attachment pins 1410 can extend through the attachment region 1406 such that the attachment pins 1410 can engage with the door. The attachment pins 1410 can be received in corresponding features of the door so as to secure the door seal to the door. In an embodiment, a head 1412 of the attachment pin 1410 can be disposed within the bulb 1402.

The gutter region 1408 can include a first gutter wiper 1414 and a second gutter wiper 1416. The first gutter wiper 1414 can extend in a vertical or near-vertical direction. First gutter wiper 1414 can be configured to contact the vehicle body, for example, at a tube of a roll-over protection system, to form a seal when the door including first door seal segment 1302 is closed. The second gutter wiper 1416 can include a curve bending towards the vertical direction. Second gutter wiper 1416 can be configured such that the second wiper is deflected towards the vertical direction by contact with the door when first door seal segment 1302 is attached to the door. In an embodiment, relief cuts 1418 can be provided on a horizontally extending portion of the gutter region 1408, on a bottom surface thereof. Relief cuts 1418 can facilitate the deflection of the second gutter wiper 1416 by contact with the door. The first gutter wiper 1414 and the second gutter wiper 1416 can define a channel therebetween when the door including the first door seal segment 1302 is closed. The channel defined by first and second gutter wipers 1414, 1416 can receive water infiltrating between the vehicle body and the door when the door is closed.

FIG. 14B shows a sectional view of an example second door seal segment. Second door segment 1306 can include second bulb 1420, second wiper 1422, second attachment region 1424 and spacing region 1426. The second bulb 1440 can have a sectional profile different from a sectional profile of bulb 1402 of the first door seal segment 1302 or second bulb 1420 of second door seal segment 1304. The second wiper 1442 can extend opposite the second attachment region 1444. Second wiper 1422 can be sized larger than first wipers 1402 or third wipers 1442 described below and shown in FIG. 14C. Second bulb 1420 and second wiper 1422 can be formed of the spongy seal materials. Second attachment region 1424 can be a planar region configured to face the door second door seal segment 1304 is to be attached to. Spacing region 1426 can extend away from the second attachment region 1424. The attachment region 1424 and spacing region 1426 can be formed of the dense seal material. Attachment pins 1410 as described above can be included in second door seal segment 1304, with the heads 1412 disposed inside second bulb 1420 and extending through second attachment region 1424.

FIG. 14C shows a sectional view of an example third door segment. Third door seal segment 1306 can include third bulb 1440 and a plurality of third wipers 1442. The third bulb 1440 can have a sectional profile different from a sectional profile of bulb 1402 of the first door seal segment 1302. Third door seal segment 1306 further includes a third attachment region 1444. Third bulb 1440 and third wipers 1442 can be formed of the spongy seal material and third attachment region 1444 can be formed of the dense seal material. Attachment pins 1410 as described above can be included in third door seal segment 1306, with the heads 1412 disposed inside third bulb 1440 and extending through third attachment region 1444.

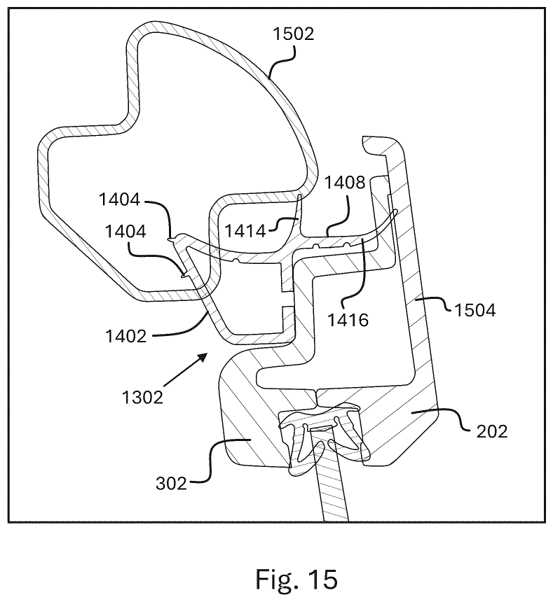

FIG. 15 shows a sectional view of an off-road vehicle at an upper portion of a door. The off-road vehicle 1500 includes roll-over protections system (ROPS) beam 1502 and door 1504. Door 1504 includes an outer panel 1506 and inner panel 1508. Door seal 1300 is provided between the ROPS beam 1502 and door 1504. The first and second gutter wipers 1414 and 1416 of first door seal segment 1302 of door seal 1300 are shown overlaid on ROPS beam 1502 and door 1504. The portions of first and second gutter wipers 1414, 1416 interfering with ROPS beam 1502 and/or door 1504 can be compressed thereby to define a channel. The channel can receive moisture entering between ROPS beam 1502 and door 1504. While ROPS beam 1502 is shown, it is understood that the door seal 1300 can seal against any one or more portions of the vehicle body proximal to the door 1504 and defining the door opening of the vehicle when the 1504 is closed.

### Aspects:

It is understood that any of aspects 1-6 can be combined with any of aspects 7-13, 14-19, 20-26, or 27-33. It is understood that any of aspects 7-13 can be combined with any of aspects 14-19, 20-26, or 27-33. It is understood that any of aspects 14-19 can be combined with any of aspects 20-26 or 27-33. It is understood that any of aspects 20-26 can be combined with any of aspects 27-33.

Aspect 1. A door for an off-road vehicle, comprising:
a door frame;
a fixed window segment, the fixed window segment including a first sealing member;
a movable window segment;
a divider bar comprising a first divider bar segment and a second divider bar segment, wherein:
the first divider bar segment includes a recess configured to receive the first sealing member,
the first divider bar segment includes a first channel opposite the recess,
the second divider bar includes a second channel, and
a second sealing member is disposed in at least one of the first channel and the second channel, the second sealing member configured to receive an edge of the movable window segment.

Aspect 2. The door according to aspect 1, wherein the second sealing member extends continuously along the first channel and the second channel.

Aspect 3. The door according to any of aspects 1-2, wherein the first divider bar includes a projection configured to be received in the door frame, the door frame configured to receive a fastener configured to interface with the projection of the first divider bar.

Aspect 4. The door according to ant of aspects 1-3, wherein the first divider bar includes a recess and the second divider bar includes a projection configured to be received in the recess, wherein the first channel and the second channer are aligned when the projection is received in the recess.

Aspect 5. The door according to any of aspects 1-4, further comprising an actuator configured to drive the movable window segment in a direction parallel to a major axis of the divider bar.

Aspect 6. An off-road vehicle comprising the door according to any of aspects 1-5.

Aspect 7. A door hinge for an off-road vehicle, comprising:
a first chassis mounting attachment, comprising a first flange including a first opening configured to receive a fastener, a first shearable door stop extending opposite the first flange, and a first hinge attachment opening;
a second chassis mounting attachment, comprising a second flange including a second opening configured to receive a fastener, a second shearable door stop extending opposite the second flange, and a second hinge attachment opening, the first hinge attachment and the second hinge attachment aligned along a hinge axis; and
a hinge arm comprising a door stop flange at a first end of the hinge arm, and a plurality of door mounting openings, the hinge arm connected to the first and second chassis mounting attachments such that the hinge arm can rotate about the hinge axis, the hinge arm configured to contact the first and second shearable door stops when the hinge arm is at a predetermined angle relative to the first and second chassis mounting attachments.

Aspect 8. The door hinge according to aspect 7, further comprising a pin door check having an axis of rotation extending along the hinge axis.

Aspect 9. The door hinge according to any of aspects 7-8, wherein the hinge arm includes a first recess configured to receive the first shearable door stop when the door hinge is in a closed position, and a second recess configured to receive the second shearable door stop when the door hinge is in the closed position.

Aspect 10. A door for an off-road vehicle, comprising a door body and the door hinge according to any of aspects 7-9, wherein the door hinge is attached to the door body by a plurality of fasteners, each of the plurality of fasteners extending through a respective one of the door mounting openings.

Aspect 11. The door according to aspect 10, wherein the first shearable door stop and the second shearable door stop are configured to be sheared by the door stop flange when a force of approximately 100 pounds is applied at an edge of the door body opposite a side of the door proximal to the door hinge.

Aspect 12. An off-road vehicle comprising the door according to any of aspects 10-11.

Aspect 13. The off-road vehicle according to aspect 12, wherein the door hinge is attached to the door body at a portion of the door body proximal to a rear of the vehicle.

Aspect 14. A door for an off-road vehicle, comprising:
a first composite panel; and
a second composite panel, wherein the first composite panel and the second composite panel define a column having a cavity between the first composite panel and the second composite panel, the first composite panel being towards an exterior of the off-road vehicle and the second composite panel being towards an interior of the off-road vehicle;
a plurality of bushings, each of the plurality of bushings extending through the first composite panel and the second composite panel at the column; and
a plurality of fastener attachments, each fastener attachment disposed at an interior end of a respective one of the plurality of bushings.

Aspect 15. The door according to aspect 14, wherein each of the plurality of bushings has a length in a range from 3 to 6 inches from an exterior-facing end of the bushing to the interior end of said bushing.

Aspect 16. The door according to any of aspects 14-15, wherein the first composite panel and the second composite panel are each formed of sheet molded compound (SMC).

Aspect 17. The door according to any of aspects 14-16, further comprising an upper hinge attachment disposed at a position on the door along the column.

Aspect 18. The door according to any of aspects 14-17, further comprising:
a hinge assembly including a hinge arm, the hinge arm including a plurality of door mounting openings; and
a plurality of fasteners, each of the plurality of fasteners extending through a respective one of the door mounting openings and a respective one of the bushings, and received in a respective one of the fastener attachments.

Aspect 19. An off-road vehicle, comprising a vehicle body and the door according to aspect 18, wherein the hinge assembly includes a vehicle body attachment connected to the hinge arm, the vehicle body attachment fixed to the vehicle body.

Aspect 20. A door seal for an off-road vehicle, comprising:
a plurality of seal segments; and
a plurality of connecting segments, each of the plurality of connecting segments connecting two of the plurality of seal segments,
wherein at least one of the plurality of seal segments has a first cross-sectional profile including a sealing bulb configured to contact a body of the off-road vehicle at a first region and a plurality of wipers configured to define a channel between a second region of the body and a frame of a door.

Aspect 21. The door seal according to aspect 20, further comprising a plurality of attachment pins, each attachment pin configured to extend through at least one of the seal segments such that the attachment pin can be received in the frame of the door.

Aspect 22. The door seal according to any of aspects 20-21, wherein at least one of the plurality of seal segments has a second cross-sectional profile including a bulb for and a plurality of wipers extending from the bulb.

Aspect 23. The door seal according to aspect 22, wherein at least one of the plurality of seal segments has a third cross-sectional profile including a bulb and a wiper extending from the bulb.

Aspect 24. The door seal according to any of aspects 20-23, wherein at least one of the plurality of seal segments includes a first material having a first density, and a second material having a second density, the second density being greater than the first.

Aspect 25. A door for an off-road vehicle comprising the door seal according to any of claims 20-24.

Aspect 26. An off-road vehicle comprising the door according to aspect 25.

Aspect 27. A door for an off-road vehicle, comprising:
a first panel formed of a sheet molded composite material, the first panel forming at least a part of an exterior-facing side of the door; and
a second panel formed of a sheet molded composite material, the second panel forming at least a part of an interior-facing side of the door,
wherein the first panel and the second panel define a column having a cavity between the first panel and the second panel, and
the first panel and the second panel define at least a portion of a window opening of the door.

Aspect 28. The door according to claim 27, further comprising a third panel forming at least a part of the interior-facing side of the door.

Aspect 29. The door according to claim 27 or claim 28, further comprising a decorative panel disposed on an exterior-facing side of the first panel.

Aspect 30. The door according to any of claims 27-29, wherein an interior-facing side of the first panel and an exterior-facing side of the second panel define an interface region, and the interface region is free of any metallic framing structure.

Aspect 31. The door according to any of aspects 27-30, the first panel and the second panel define a channel configured to receive at least a portion of a sealing member, the channel provided along at least a portion of the perimeter of the window opening of the door.

Aspect 32. The door according to any of aspects 27-31, further comprising:
a plurality of bushings, each of the plurality of bushings extending through the first panel and the second panel at the column; and
a plurality of fastener attachments, each fastener attachment disposed at an interior end of a respective one of the plurality of bushings.

Aspect 33. An off-road vehicle comprising the door of any of claims 27-32.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A door for an off-road vehicle, comprising:
a door frame;
a fixed window segment, the fixed window segment including a first sealing member;
a movable window segment;
a divider bar comprising a first divider bar segment and a second divider bar segment, wherein:
the first divider bar segment includes a recess configured to receive the first sealing member,
the first divider bar segment includes a first channel opposite the recess,
the second divider bar includes a second channel, and
a second sealing member is disposed in at least one of the first channel and the second channel, the second sealing member configured to receive an edge of the movable window segment.

2. The door of claim 1, wherein the second sealing member extends continuously along the first channel and the second channel.

3. The door of claim 1, wherein the first divider bar includes a projection configured to be received in the door frame, the door frame configured to receive a fastener configured to interface with the projection of the first divider bar.

4. The door of claim 1, wherein the first divider bar includes a recess and the second divider bar includes a projection configured to be received in the recess, wherein the first channel and the second channer are aligned when the projection is received in the recess.

5. The door of claim 1, further comprising an actuator configured to drive the movable window segment in a direction parallel to a major axis of the divider bar.

6. An off-road vehicle comprising the door of claim 1.

7. A door hinge for an off-road vehicle, comprising:
a first chassis mounting attachment, comprising a first flange including a first opening configured to receive a fastener, a first shearable door stop extending opposite the first flange, and a first hinge attachment opening;
a second chassis mounting attachment, comprising a second flange including a second opening configured to receive a fastener, a second shearable door stop extending opposite the second flange, and a second hinge attachment opening, the first hinge attachment and the second hinge attachment aligned along a hinge axis; and
a hinge arm comprising a door stop flange at a first end of the hinge arm, and a plurality of door mounting openings, the hinge arm connected to the first and second chassis mounting attachments such that the hinge arm can rotate about the hinge axis, the hinge arm configured to contact the first and second shearable door stops when the hinge arm is at a predetermined angle relative to the first and second chassis mounting attachments.

8. The door hinge of claim 7, further comprising a pin door check having an axis of rotation extending along the hinge axis.

9. The door hinge of claim 7, wherein the hinge arm includes a first recess configured to receive the first shearable door stop when the door hinge is in a closed position, and a second recess configured to receive the second shearable door stop when the door hinge is in the closed position.

10. A door for an off-road vehicle, comprising a door body and the door hinge of claim 7, wherein the door hinge is attached to the door body by a plurality of fasteners, each of the plurality of fasteners extending through a respective one of the door mounting openings.

11. The door of claim 10, wherein the first shearable door stop and the second shearable door stop are configured to be sheared by the door stop flange when a force of approximately 100 pounds is applied at an edge of the door body opposite a side of the door proximal to the door hinge.

12. An off-road vehicle comprising the door of claim 10.

13. The off-road vehicle of claim 12, wherein the door hinge is attached to the door body at a portion of the door body proximal to a rear of the vehicle.

14. A door for an off-road vehicle, comprising:
a first composite panel; and
a second composite panel, wherein the first composite panel and the second composite panel define a column having a cavity between the first composite panel and the second composite panel, the first composite panel being towards an exterior of the off-road vehicle and the second composite panel being towards an interior of the off-road vehicle;
a plurality of bushings, each of the plurality of bushings extending through the first composite panel and the second composite panel at the column; and
a plurality of fastener attachments, each fastener attachment disposed at an interior end of a respective one of the plurality of bushings.

15. The door of claim 14, wherein each of the plurality of bushings has a length in a range from 3 to 6 inches from an exterior-facing end of the bushing to the interior end of said bushing.

16. The door of claim 14, wherein the first composite panel and the second composite panel are each formed of sheet molded compound (SMC).

17. The door of claim 14, further comprising an upper hinge attachment disposed at a position on the door along the column.

18. The door of claim 14, further comprising:
a hinge assembly including a hinge arm, the hinge arm including a plurality of door mounting openings; and
a plurality of fasteners, each of the plurality of fasteners extending through a respective one of the door mounting openings and a respective one of the bushings, and received in a respective one of the fastener attachments.

19. An off-road vehicle, comprising a vehicle body and the door of claim 18, wherein the hinge assembly includes a vehicle body attachment connected to the hinge arm, the vehicle body attachment fixed to the vehicle body.

20. A door seal for an off-road vehicle, comprising:
a plurality of seal segments; and
a plurality of connecting segments, each of the plurality of connecting segments connecting two of the plurality of seal segments,
wherein at least one of the plurality of seal segments has a first cross-sectional profile including a sealing bulb configured to contact a body of the off-road vehicle at a first region and a plurality of wipers configured to define a channel between a second region of the body and a frame of a door.

21. The door seal of claim 20, further comprising a plurality of attachment pins, each attachment pin configured to extend through at least one of the seal segments such that the attachment pin can be received in the frame of the door.

22. The door seal of claim 20, wherein at least one of the plurality of seal segments has a second cross-sectional profile including a bulb for and a plurality of wipers extending from the bulb.

23. The door seal of claim 22, wherein at least one of the plurality of seal segments has a third cross-sectional profile including a bulb and a wiper extending from the bulb.

24. The door seal of claim 20, wherein at least one of the plurality of seal segments includes a first material having a first density, and a second material having a second density, the second density being greater than the first.

25. A door for an off-road vehicle comprising the door seal of claim 20.

26. An off-road vehicle comprising the door of claim 25.

27. A door for an off-road vehicle, comprising:
a first panel formed of a sheet molded composite material, the first panel forming at least a part of an exterior-facing side of the door; and
a second panel formed of a sheet molded composite material, the second panel forming at least a part of an interior-facing side of the door,
wherein the first panel and the second panel define a column having a cavity between the first panel and the second panel, and
the first panel and the second panel define at least a portion of a window opening of the door.

28. The door of claim 27, further comprising a third panel forming at least a part of the interior-facing side of the door.

29. The door of claim 27, further comprising a decorative panel disposed on an exterior-facing side of the first panel.

30. The door of claim 27, wherein an interior-facing side of the first panel and an exterior-facing side of the second panel define an interface region, and the interface region is free of any metallic framing structure.

31. The door of claim 27, wherein the first panel and the second panel define a channel configured to receive at least a portion of a sealing member, the channel provided along at least a portion of the perimeter of the window opening of the door.

32. The door of claim 27, further comprising:
a plurality of bushings, each of the plurality of bushings extending through the first panel and the second panel at the column; and
a plurality of fastener attachments, each fastener attachment disposed at an interior end of a respective one of the plurality of bushings.

33. An off-road vehicle comprising the door of claim 27.
